(19) United States
(12) Patent Application Publication
(10) Pub. No.: US 2006/0267994 A1
(43) Pub. Date: Nov. 30, 2006

(54) Armrest personal digital media system

(75) Inventors: Gerald W. Pfleging, Batavia, IL (US); George Paul Wilkin, Bolingbrook, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/141,462

(22) Filed: May 31, 2005

(51) Int. Cl. G06T 1/60

(52) U.S. Cl. 345/530

(57) ABSTRACT

This invention relates to an armrest personal digital media system. More particularly, this invention is provided to allow individuals to use a portable, removable digital storage device in conjunction with an armrest system to provide personalized entertainment options on airplanes, or other mass transportation modes. Implementation of this invention will allow users to enjoy their own digital entertainment choices without requiring the owning, carrying, toting or powering of digital playing devices or computers while in transit. The invention provides the armrest of a seat with a variety of modules, including a memory interface module, to allow for a removable memory device to be engaged with the playback/record components of an armrest to play/record content via an audio player/recorder and/or a video player/recorder.

### BACKGROUND OF THE INVENTION

This invention relates to an armrest personal digital media system. More particularly, this invention is provided to allow individuals to use a portable, removable digital storage device in conjunction with an armrest system to provide personalized entertainment options on airplanes, or other mass transportation modes such as trains, buses or automobiles. Implementation of this invention will allow users to enjoy their own digital entertainment choices without requiring the owning, carrying, toting or powering of digital playing devices or computers while in transit. In one form, the invention provides the armrest of a seat with a variety of modules, including a memory interface module, to allow for a removable memory device to be engaged with the playback/record components of an armrest to play/record content via an audio player/recorder and/or a video player/recorder.

While the invention is particularly directed to the art of personal digital media systems housed within an armrest of a seat in a mass transit carrier, and will be thus described with specific reference thereto, it will be appreciated that the invention may have usefulness in other fields and applications. For example, the techniques of the invention may be used where it is desirable to allow for playing of personal media content.

By way of background, travelers have steadily continued to purchase and carry, especially while traveling, an increased number of personal electronic devices. In addition to the devices themselves, the media items (e.g., compact disks (CDs), digital video disks (DVDs), . . . etc.) that are typically needed to store the data (e.g., audio data, video data, game data) that is used to provide the entertainment, are also carried. The amount of baggage and equipment that is brought on board mass transit carriers, for example, is a problem. The addition of new electronic equipment does not alleviate this problem. In addition to the space problems associated with extra equipment, there are problems with the potential for electrical interference from the personal systems to the internal systems of the mass transit carrier plane (EMF) and problems with powering the equipment.

A solution attempted by mass transit carriers, such as airlines, is to install personal in-seat (i.e., back of seat) entertainment systems. Typical systems are becoming increasingly feature rich with LCD displays and full keypads for use in watching satellite TV, listening to satellite radio or game playing. These systems, however, do not allow for a passenger to bring his/her own content on board and play it. Further, such systems do not allow for a download of content to the passenger.

The present invention contemplates a new and improved personal digital media system that resolves the above-referenced difficulties and others.

### SUMMARY OF THE INVENTION

A method and apparatus for an armrest personal digital media system is provided.

In one aspect of the invention, the system comprises a memory interface module within the armrest operative to receive a removable memory device; a recognition module within the armrest operative to recognize engagement of the memory device with a memory interface module and further operative to recognize a format of content of the memory device; and, an audio player within the armrest operative to play the content of the memory device based on the format.

In another aspect of the invention, the seat is an airplane seat.

In another aspect of the invention, the seat is a seat on a mass transit vehicle.

In another aspect of the invention, the system further comprises a control module having a control interface that is accessible by a user.

In another aspect of the invention, the system further comprises a video player within the armrest operative to play the content based on the format.

In another aspect of the invention, the system further comprises a video display operative to display the played content.

In another aspect of the invention, the system further comprises a lock-out module operative to control the playing of content.

In another aspect of the invention, the system further comprises an audio component operative to receive audio data from a network server and record the audio data on the memory device.

In another aspect of the invention, the system further comprises a video component operative to receive video data from a network server and record the video data on the memory device.

In another aspect of the invention, a method comprises receiving a removable memory device by a memory interface module of an armrest; recognizing engagement of the memory device with the memory interface module by recognition module; recognizing a format of content of the memory device by the recognition module; and, playing the content of the memory device based on the format.

In another aspect of the invention, the seat is an airplane seat.

In another aspect of the invention, the seat is a seat on a mass transit vehicle.

In another aspect of the invention, the method further comprises accessing a control interface of a control module.

In another aspect of the invention, the method comprises playing the content by an audio player based on the format.

In another aspect of the invention, the method comprises playing the content by a video player based on the format.

In another aspect of the invention, the method further comprises displaying the played content on a video display.

In another aspect of the invention, the method further comprises controlling the playing of the content by a lock-out module.

In another aspect of the invention, the method further comprises receiving audio data from a network server and recording the audio data on the memory device.

In another aspect of the invention, the method further comprises receiving video data from the network server and recording the video data on the memory device.

In another aspect of the invention, the system comprises a memory interface module within the armrest operative to receive a removable memory device, a recognition module within the armrest operative to recognize engagement of the memory device with the memory interface module and further operative to recognize a format of content of the memory device, the format comprising at least one of an audio format and a video format, an audio player within the armrest operative to play the content of the memory device based on the audio format, a video player within the armrest operative to play the content based on the video format, an audio component operative to receive audio data from a network server and record the audio data on the memory device, and a video component operative to receive video data from the network server and record the video data on the memory device.

In another aspect of the invention, a mechanical ejector device is provided to eject the memory device from the memory interface module.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is an illustration of an embodiment of the present invention;

FIG. 2 is another view of the embodiment of FIG. 1;

FIG. 3 is a block diagram of a component according to the present invention;

FIG. 4 is a block diagram of a component according to another embodiment of the present invention;

FIG. 5 is a block diagram of a component of another embodiment of the present invention;

FIG. 6 is a representative view of a memory interface module according to the present invention; and,

FIG. 7 is a flow chart illustrating a method according to the present invention.

### DETAILED DESCRIPTION OF THE PREFERRED EMBODIMENTS

According to the present invention, a personal digital media system is implemented. In at least one form, the system is installed at each seat (e.g., most components within the armrest) and allows for the connection of a memory storage device, such as a USB memory stick, into the armrest. The system powers the storage device, if necessary, and scans it for its content. Upon finding acceptable file formats, the system displays to the user the choices of what to play. The user may use the armrest ‘channel’ controls to move from choice to choice. The armrest may include a button to start play or just begin playing the currently highlighted selection after ‘X’ seconds. Using the ‘channel’ control while in playback would pause or stop the media being played based on the number or length of the presses. Alternative embodiments may utilize touch screen or other input technologies.

The connection in the armrest may be wired to a central or distributed networking device within the carrier (e.g., plane, train, bus, . . . etc.) creating a standard Ethernet network to carry the signals to a destination. Several aircraft manufacturers, for example, are offering wired network systems on their new planes or are retrofitting them into older aircraft.

The system could be either free or for charge, and the charges could be controlled in a number of ways, such as charging for turning the unit on, charging for the headset (using a custom plug for the headset), metering the usage and charging it to the account of the person that paid for the seat.

The memory or storage devices may be owned by the person in the seat or provided to the passenger by the carrier or other third party. The airline (or travel company) could rent, sell or give away devices that contain content the user might like to watch. This is similar to current use of in-dash CD/MP3 radios in cars.

Memory devices such as USB stick memories are well known. These memories are compact, low power consuming, and able to hold large amounts of data. Compact Flash, SD/MD/xD, Memory Stick and many of the other portable storage media also have such a configuration. The files stored on the memory devices and supported by the media playing device of the present invention may include all of the current popular formats (MP3, Mpeg (v 1-4), (DIVX, WMA, Ogg Vorbis) and others.

There could be additions to the system in alternative embodiments that would allow for the checking of the media ownership and playback rights that would prevent the playback of banned/non-owned materials. The meta-data in the digital media may also be used to restrict video playback of programs believed not suitable for playback in such a location (e.g., adult material could be blocked).

In some embodiments, the system may allow for a port or a port converter to allow the installation of personal video game cartridges. The files stored on the personal storage device may then contain game files. A game controller, or other personal controller or some combination, may also be employed using the port.

In still further embodiments, the system is also able to allow for the passengers to purchase digital media from an onboard server and have it placed on their digital media storage device.

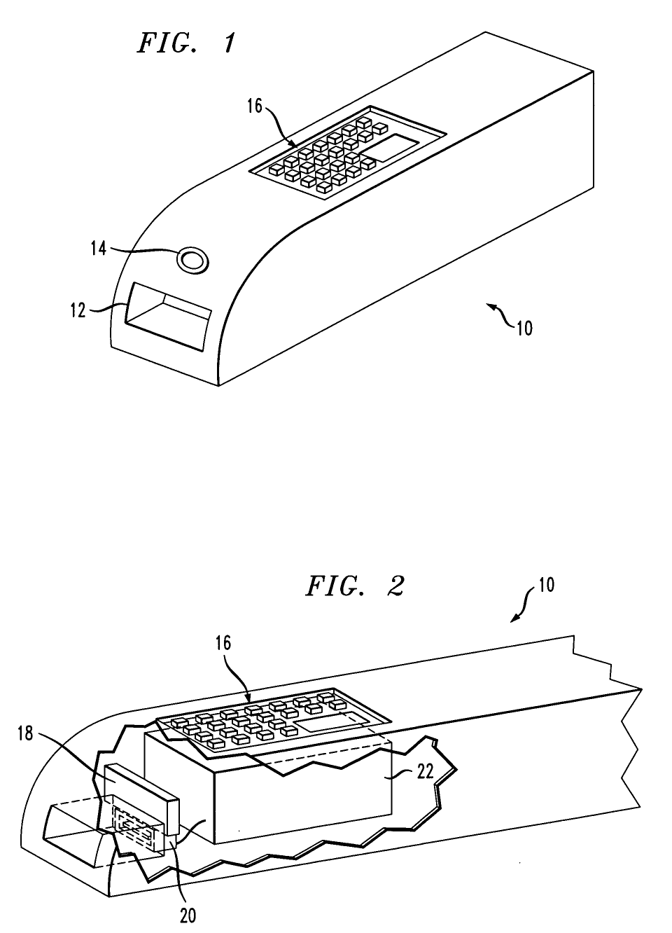

Referring now to the drawings wherein the showings are for purposes of illustrating the preferred embodiments of the invention only and not for purposes of limiting same, FIG. 1 provides a view of an armrest according to the present invention. As shown, an armrest 10 includes a memory device slot 12 that is operative to receive a removable memory device, such as a USB memory stick, compact flash, or other memory stick-type device. Indeed, the memory device used could take any of a variety of forms for portable storage media, provided that its dimensions are such that it can be received within the slot 12. Also shown on the armrest are a jack or port 14 and a control interface 16.

It should be appreciated that the armrest 10 could be the armrest of an airplane seat, or the seat of any other mass transit carrier such as a train, a bus, a van, . . . etc. The armrest 10 may also take a variety of configurations depending on the implemented seat design. Further, it should be appreciated that the components of the invention may be incorporated within an automobile to allow a user to achieve the objectives of the present invention. In this regard, the armrest 10 may take the form of a pull down armrest that is typically located in the back seat or the front seat of a vehicle.

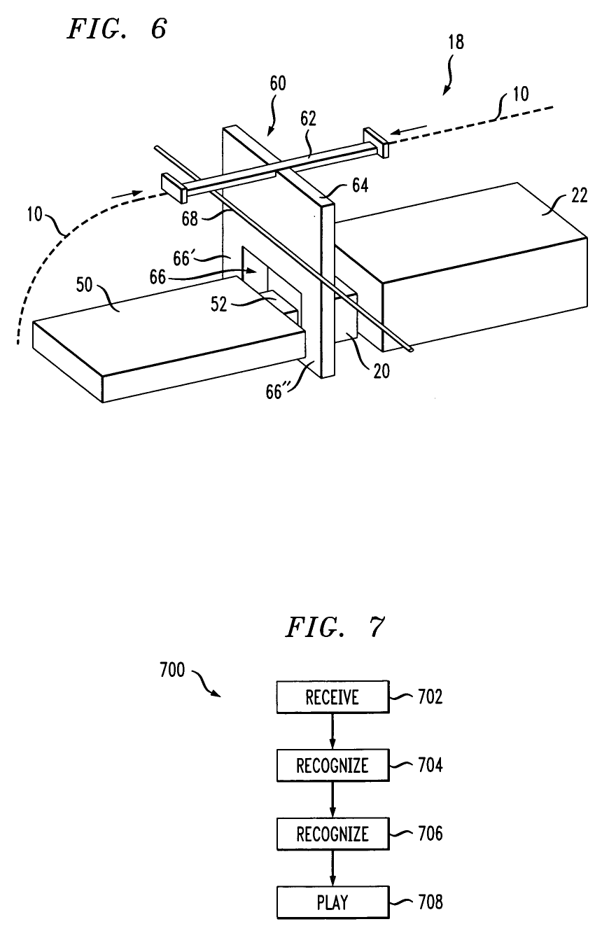

The slot 12 is dimensioned to receive a memory device, as noted above. In at least one form, slot 12 is also deep enough to receive the entire memory stick so that the surface of the armrest remains flush to the user. Of course, various configurations of the slot 12 and related components implemented in accord with the present invention may exist, including that which is described in connection with FIG. 6, to be described in greater detail below.

The jack or port 14 may be used for a variety of functions depending on the specific design. For example, the jack or port 14 may be used to connect equipment that would allow for the playing of video games on the system. In this regard, the video and/or audio functionality of the system of the present invention may allow for the playing and implementation of these games. Any modifications to the system to accommodate these features will be well known to those skilled in the art with an understanding of the present invention. However, it will be understood that the connection of certain components of the games, such as a game controller, a video game cartridge device, or the like, can be realized through this port. The jack or port 14 may also be provided to allow for connection of a phone into the system. Still further, the jack or port 14 may be compatible with a converter that would allow for the convenient connection of a gaming system.

The functionality of control interface 16 is described in more detail in connection with FIGS. 3, 4 and 5. However, it should be appreciated that the control interface 16 may be made up of control elements currently used on airline seat armrests. Or, it could be comprised of components that would provide a more convenient interface for the user (e.g., a touch screen). A combination of existing seat armrest interface components and additional components may also be used. Any such implementations will suffice and will be apparent, in operation and function, to those skilled in the art with an understanding of the present embodiments.

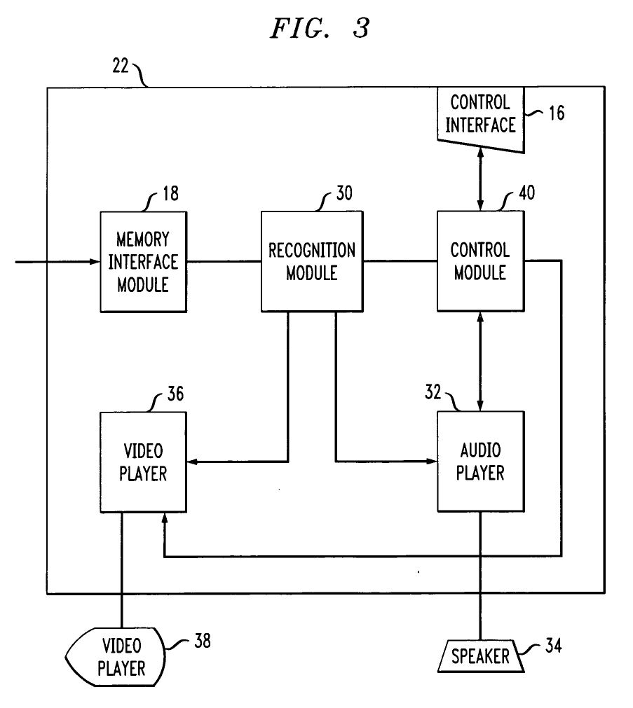

Referring now to FIG. 2, an alternative view of the armrest 10 of FIG. 1 is shown. In this view, the armrest 10 is shown as having the control interface 16. In addition, a memory interface module 18 is also illustrated. In at least one form, the memory interface module 18 is provided at one end of the slot 12 and includes a connector 20 that is compatible with the contemplated memory devices that may used in connection with the present invention. For example, the connector 20 may be a USB connector. Other components, such as a mechanical ejector apparatus of FIG. 6, may also be included as a part of the memory interface module 18, although not specifically shown here. In addition, FIG. 2 illustrates a processing module 22 which, as shown, is housed within the armrest 10.

Referring now to FIG. 3, processing module 22 is shown in greater detail. As illustrated, the processing module 22 is provided with the memory interface module 18. It will be understood that the memory interface module 18 may be housed within the processing module 22 or simply connected to the processing module 22. In this regard, the connector 20 is a part of the memory interface module 18 and may be housed entirely within the module 22, entirely outside the module 22 or partially within and partially outside the module 22. It may also be implemented as part of or in conjunction with the slot 12. As will be seen below, the mechanical ejector apparatus of the memory interface module 18, shown in more detail in FIG. 6, is supported by the hardware defining the slot 12, in one form.

The memory interface module 18 is in communication with a recognition module 30 which, in turn, is in communication with an audio player 32. The audio player 32 plays sounds through a speaker 34. In some embodiments, a video player.36 is also provided to the processing module 22. Of course, the video player 36 is connected to a video display unit 38 for playing video contents. It should be understood that the video player 36 is not a necessary element to the configuration shown in the processing module 22. Also shown is a control module 40 which connects to the control interface 16 noted above.

In operation, a memory stick is engaged with and received by the memory interface module 18 and, ultimately, initiates operation of the processing module 22. When the memory interface module 18 receives the memory device through the slot 12, the recognition module 30 recognizes engagement of the memory device with the connector 20 of the memory interface module 18. Of course, such recognition could be realized through techniques that are well known in the field, e.g. through detection of physical or electronic presence of the memory.

The recognition module 30 also operates to recognize a format of the content of the memory device. The format could be a variety of formats, including audio formats such as MP3. This recognition could be realized using a variety of techniques that are well known to those skilled in the field. For example, recognition routines that are currently implemented on conventional audio and video players could be adapted for use in connection with the present invention.

The audio player 32 then plays, through speaker 34, the content of the memory device based on the recognition of the audio format. Of course, if the format is a video format and the module 22 includes the video player 36, the video player 36 plays the content based on the video format and displays the content on the video display 38.

It should be understood that either the audio player 32, and associated hardware and software, or video player 36, and associated hardware and software, may be omitted from the processing module 22. For example, depending on the objectives of the user population, the mass transit carrier may only wish to provide audio content features to its passengers. In this case, the video player 36 and video display 38 would be omitted and the recognition module would not necessarily include the feature of recognizing video formatted data. Of course, such an adaption to remove the video player could be advantageously implemented in current or new personal entertainment systems that do not possess a video display or screen.

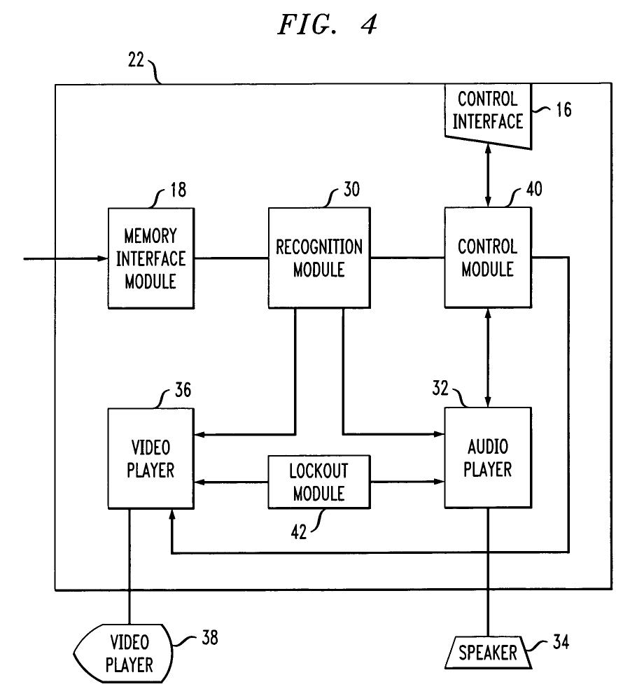

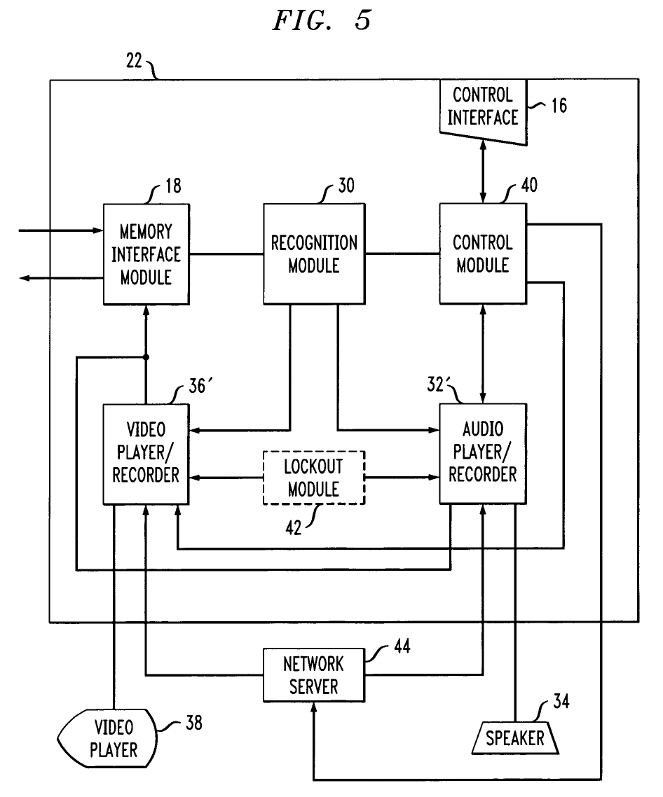

Likewise, the audio player 32 and associated components may be removed from the system. It will be understood that the removal of elements, whether the audio components or video components, also applies to other embodiments described herein, such as those described in connection with FIGS. 4 and 5.

With reference now to FIG. 4, the processing module 22 takes substantially the same form as that of FIG. 3. However, the processing module in FIG. 4 also includes a lock-out module 42. The lock-out module 42 includes various software routines that allow for the control of the content that is actually played on either the audio player or the video player. For example, the lock-out module may use meta-data of the video or audio data content, or rating units or the like, to prevent the playing of certain content during certain hours. For example, the lock-out module 42 may lock out certain adult content during daytime hours. The implementation of the lock-out module may take a variety of different forms. For example, it may be located within the processing module, centralized in the network for the carrier (e.g., in a network server), or distributed among those components or others. Also, those of skill in the art will understand the technical features associated therewith. Also, as above, either the audio player 32 or the video player 36 may be omitted.

Referring now to FIG. 5, the processing module 22 again takes a form similar to that of FIGS. 3 and 4. However, the processing module 22 only optionally includes the lock-out module 42, and also includes an audio player 32′ that also has a recording or downloading functionality. Likewise, the video player 36′ also includes a recording or downloading functionality. This allows for the download of content, whether audio or video content, from a network server 44 to a user memory device through the recording devices 32′ and 36′.

In operation, if a user desires to download content, the user would simply utilize the control interface 16 to initiate operations of the control module 40 to do so. Once the user initiates this process, the network server 44 would simply download the desired content to either the audio player/recorder or video player/recorder which would then be stored in the memory device that is received in the memory interface module 18. Of course, the process of downloading data from a server and storing it on a memory are well known in other implementations. However, here, doing so through a personal entertainment system implemented in an armrest of a vehicle is not heretofore known.

It should be also appreciated that this functionality may be used by mass transit carriers or other vehicle providers in a variety of different fashions. For example, it may be used as a benefit to be provided to paid passengers or may be a charge service for those wishing to utilize the download feature. This functionality will also be accessible to the user through the control module 40 and control interface 16.

It should also be understood that a download feature may be implemented in other fashions, such as in the manner described in co-pending U.S. patent application Ser. No. 11/087,444, filed Mar. 23, 2005, entitled “Self-Service Acquisition of Digital Content,” which is incorporated herein by reference in its entirety. In that application, a user download interface is disclosed for use in a self-service environment. This configuration could be adapted to implementation in the context of the present application.

Referring now to FIG. 6, a more detailed portion of the interface module 18 housed within the armrest 10 (shown only partially in phantom) is illustrated. The interface module 18 receives the memory device 50 by way of the slot 12 (not shown for simplicity) and USB connector 20. Specifically, the connector 20 receives a mating USB connector 52 located on the memory device 50. An ejector mechanism 60 allows for the convenient removal of the memory device 50 in situations where the memory device 50, when plugged in to the USB port 20, remains flush with the contour of the armrest. Along these lines, the end of the memory device 50 would not be easily accessible to a user because the entire memory device would be received within the slot 12. The mechanism 60 pushes the memory device 50 out of the slot 12.

To implement this device, a lever 62 connects to a plate 64. The plate 64 has a cut-out portion 66 that defines two forks 66′ and 66″ in the plate 64 that can be used to push the memory device 50 to disengage the connectors 20 and 52 and to push the memory device 50 out of the slot 12. To accomplish the requisite action, a pivot 68 is provided. In operation, the lever 62 is simply actuated to turn the plate 64 (to which it is engaged in any suitable manner) about its pivot to push the memory device out of the slot 12. As noted above, these mechanical elements 62, 64 and 68 are supported by the portions of the armrest that define the slot 12.

It should also be understood that, while the mechanism 60 is formed of few components and is manually actuated, other alternatives may be employed to provide desired movement of the memory device 50. For example, various configurations an ejector mechanism are described in co-pending U.S. patent application Ser. No. 11/087,444, filed Mar. 23, 2005, entitled “Self-Service Acquisition of Digital Content,” incorporated herein by this reference. The structures may be adapted to and implemented in the environment of the present invention. Of course, other ejector mechanisms are also contemplated by the present invention.

Referring now to FIG. 7, a flow chart illustrating a method according to the present invention is illustrated. As shown, a method 700 includes the step of receiving the removable memory device in the memory interface module 18 of the armrest 10 (at step 702). A recognition module 30 then recognizes engagement of the memory device 50 with the memory interface module 18 (at step 704). Next, the recognition module 30 recognizes a format of the content of the memory device 10 (at step 706). Then, an audio player 32 or video player 36simply plays the content of the memory device based on the format (at step 708).

Of course, other portions of a method may be implemented in the present invention, although not shown in FIG. 7. For example, it should be understood that if video content is played, the video content may be displayed on a display unit. Further, the content, whether video or audio, may be controlled through use of a lock-out module 42. Still further, the method may also include steps for downloading or recording data onto a memory device of a user through various audio and video components, such as an audio recorder and/or a video recorder.

The methods of the present invention may be implemented using a variety of software techniques and hardware environments that will be apparent to those with an understanding of the present invention. For example, the method of FIG. 7 (and related method features) may be distributed throughout the recognition module, control module and respective player modules. However, the software routines implementing the invention may be centralized, whereby the elements described herein would represent a logical architecture for the invention.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A digital media system for use within an armrest of a seat, the system comprising:
a memory interface module within the armrest operative to receive a removable memory device;
a recognition module within the armrest operative to recognize engagement of the memory device with the memory interface module and further operative to recognize a format of content of the memory device; and,
an audio player within the armrest operative to play the content of the memory device based on the format.

2. The system as set forth in claim 1 wherein the seat is an airplane seat.

3. The system as set forth in claim 1 wherein the seat is a mass transit carrier seat.

4. The system as set forth in claim 1 further comprising a control module having a control interface that is accessible by a user.

5. The system as set forth in claim 1 further comprising a video player within the armrest operative to play the content based on the format.

6. The system as set forth in claim 5 further comprising a video display operative to display the plate content.

7. The system as set forth in claim 1 further comprising a lock-out module operative to control the playing of content.

8. The system as set forth in claim 1 further comprising an audio recorder operative to receive audio data from a network server and record the audio data on the memory device.

9. The system as set forth in claim 1 further comprising a video component operative to receive video data from a network server and record the video data on the memory device.

10. A method for use with a digital media system within an armrest of a seat, the method comprising:
receiving by a memory interface module a removable memory device by a memory interface module of the armrest;
recognizing engagement of the memory device with the memory interface module by a recognition module within the armrest;
recognizing a format of content of the memory device by the recognition module; and, playing the content of the memory device based on the format.

11. The method as set forth in claim 10 wherein the seat is an airplane seat.

12. The method as set forth in claim 10 wherein the seat is a mass transit carrier seat.

13. The method as set forth in claim 10 further comprising accessing a control module having a control interface by a user.

14. The method as set forth in claim 10 wherein the playing comprises playing the content by an audio player based on the format.

15. The method as set forth in claim 10 wherein the playing comprises playing the content by a video player based on the format.

16. The method as set forth in claim 15 further comprising displaying the played content on a video display.

17. The method as set forth in claim 10 further comprising controlling the playing of the content through a lock-out module.

18. The method as set forth in claim 10 further comprising receiving by an audio recorder audio data from a network server and recording the audio data on the memory device.

19. The method as set forth in claim 10 further comprising receiving video data from a network server and recording the video data on the memory device by a video recorder.

20. A digital media system for use within an armrest of a seat, the system comprising:
a memory interface module within the armrest operative to receive a removable memory device;
a recognition module within the armrest operative to recognize engagement of the memory device with the memory interface module and further operative to recognize a format of content of the memory device, the format comprising at least one of an audio format and a video format;
an audio player within the armrest operative to play the content of the memory device based on the audio format;
a video player within the armrest operative to play the content based on the video format;
an audio component operative to receive audio data from a network server and record the audio data on the memory device; and, a video component operative to receive video data from the network server and record the video data on the memory device.

21. The system as set forth in claim 20 wherein the memory interface module is provided with a mechanical ejector operates for ejecting the removable memory device therefrom.
